(19) United States
(12) Patent Application Publication
(10) Pub. No.: US 2004/0247487 A1
(43) Pub. Date: Dec. 9, 2004

(54) Means for extracting products to be analysed and applications thereof in diagnosis and analysis

(76) Inventors: Pierre Commercon, Caluire (FR); Henri-Pierre Deliou, Caluire (FR)

Correspondence Address: CONLEY ROSE, P.C., P. O. BOX 3267, HOUSTON, TX, 77253-3267, US

(21) Appl. No.: 10/469,681

(22) PCT Filed: Mar. 1, 2002
(86) PCT No.: PCT/FR02/00762

(30) Foreign Application Priority Data
Mar. 2, 2001 (FR) 0102915

(51) Int. Cl. G01N 1/18

(52) U.S. Cl. 422/99; 436/177

(57) ABSTRACT

The invention relates to means for extracting products to be analysed. Said means comprise a device for extracting one or more layers comprising the sought-after products or constituents from a test tube (1) containing numerous different adjacent or overlapping layers in a liquid medium forming a continuous or discontinuous density gradient (2). Said invention is characterised in that it comprises: a standard test tube (1), an extraction capillary or tube (3), which can be pre-positioned according to the layer to be extracted, and means for obtaining a laminar flow of one or more layers from the tube without suction, either by applying overpressure to the top of the liquid medium with a low-density liquid, gas or fluid or by exerting a centrifugal force. The invention can be used to extract one or more layers of constituents, for example, from a blood mixture.

The invention relates to means, devices, processes and kits, for extracting products for analysis that are contained in a layer located in a continuous or discontinuous gradient of different products in a liquid medium. The term “products” covers products in solution and liquids.

It also relates to the applications in analysis and in diagnosis of these means, in particular to the early detection of foetal genetic diseases.

The establishment of a diagnosis often requires the isolation by extraction of the desired constituents present in a layer separated by a density gradient. In the description and the claims, the terms “layer”, “strip” or “fraction” will be used equally to designate the products separated according to their real or apparent density.

In usual laboratory practice, this layer is extracted by the technician, from an analysis tube, by suction, by drilling or by cutting of the tube, which presents at least two major difficulties: the desired strip is isolated partially and it is contaminated by the upstream and downstream regions following a turbulent flow, which brings about a remixing that destroys the effectiveness of the technique of separation by density. In fact, the reduced pressure necessary for the suction of the product causes a vortex which mixes the neighbouring layers. It will be noted that the expression “analysis tube” is used in its most general sense to designate any container.

In order to overcome the above disadvantages, the inventors have developed extraction means, devices, processes and kits, for any fraction positioned anywhere in a continuous or discontinuous gradient of different products.

From a separation based on the difference in real or apparent density, these means allow any fraction to be completely isolated, without the mixing phenomenon.

The inventors have also developed injection means, devices, processes and kits, allowing layers to be deposited in an analysis tube without mixing at the level of the interfaces, the specific extraction of one or more layers then being realized according to a given technique, in particular as referred to according to the invention.

The aim of the invention is therefore to provide such means for selective extraction of products for analysis that are contained in a layer of a density gradient.

It also aims to provide means for the injection of such layers.

The invention also relates to applications of the means of injection and/or of extraction for analysis and diagnosis, exploiting their advantages of selectivity, reliability and simplicity.

The device for the extraction of one or more strips containing the desired products or constituents from an analysis tube (1) containing a plurality of separate adjacent or overlapping strips, in a liquid medium, forming a continuous or discontinuous density gradient (2), is characterized in that it comprises

a standard analysis tube (1),

an extraction tube (3), hereinafter called extraction capillary, which can be pre-positioned according to the layer to be extracted, and

means for obtaining a laminar flow without suction of one or more strips from the tube, either by applying excess pressure onto the top of the liquid medium, with a fluid, gas or liquid of low density, or by exerting a centrifugal force.

Thanks to these arrangements, with this technique it is possible to extract all the layers successively and in a laminar manner, without mixing.

The invention also relates to a process for specific extraction of one or more strips containing the desired products or constituents from an analysis tube as indicated above.

This process is characterized by the following stages:

an extraction capillary is introduced into a standard analysis tube using a guide ensuring its positioning in the space at the desired height in relation to the strip to be extracted or, as a variant, an analysis tube is used with a capillary pre-positioned at the desired height, located inside or partly outside the tube, and

means are applied for obtaining a laminar flow without suction, either by excess pressure with a fluid, gas or liquid of low density, or by exerting a centrifugal force.

The invention also provides kits allowing the said extractions to be carried out. These kits are characterized in that they comprise all or part of the extraction device such as defined above, and the products for the implementation of the extraction process of the invention, such as the separating medium and/or the reagents allowing a selective separation of desired constituents.

The extraction process defined above is advantageously applied to layers deposited, according to the invention, at determined heights and according to an original technique allowing the mixing of the products to be avoided at the level of the interfaces.

Thus, according to the invention, the injection into an analysis tube of products, in the form of successive layers, by the introduction of predetermined quantities of products or of liquids with different densities is carried out with the aid of a device characterized in that the analysis tube (1) comprises injection means allowing the products to arrive tangentially in predetermined quantities.

It will be noted with interest that such a device facilitates operations, standardizes the deposition of layers at predetermined product heights and allows the mixing of the products to be avoided at the level of the interfaces, thus resolving the basic problem of the mixing of the products at the level of the interfaces between the different layers.

The injection process with the aid of such a device also falls within the scope of the invention. This process is characterized in that the requisite quantities of products or of liquids for a given layer are injected into the analysis tube with the aid of a pipette or a calibrating dispenser, in order to bring the product tangentially to the surface of the preceding layer or, as a variant, the said products or liquids are introduced into the analysis tube with the aid of a needle with a tangential injection nozzle, the penetration height being predetermined according to the height of the previously formed layers.

According to yet another aspect, the invention relates to kits for the injection of successive layers of products into an analysis tube, these kits comprising all or part of an injection device such as defined above and individual doses of products or of liquids pre-calibrated according to the stacking of the layers to be realized.

With the devices, processes and kits described above for the preparation of the layers of products and the extraction of the desired constituents, the invention provides high-specificity means of separation of desired products for an analysis and in particular is of great interest for the separation of the different constituents of a mixture.

The invention relates in particular to the application of these devices and/or processes and/or kits in order to separate the constituents of a blood mixture in a separating medium containing, if appropriate, an anti-aggregating agent, and in order to recover them in a selective manner.

The invention relates quite specially to such an application in order to extract the foetal erythroblasts from maternal blood, which allows an early detection of foetal genetic diseases during gestation.

It is known that, in the separation of nucleated foetal cells, in comparison with maternal cells, it is customary to use the variations in cell density, for obvious reasons of simplicity.

The two best-known techniques are based on the use of Ficoll® or of Percoll®. The Percoll® technique allows a continuous density gradient to be realized. Given its accuracy, this method is often employed in order to separate foetal cells from adult cells. The removal of a part of the Percoll® gradient allows very pure foetal cells to be recovered, but in a very small quantity. The Ficoll® technique allows discontinuous gradients to be realized and more foetal erythroblasts to be recovered. The problem posed by this method is the elimination of the contaminating adult cells removed at the same time as the foetal cells.

On the basis of this simple Ficoll® technique, the inventors have developed a process allowing the different constituents of a blood mixture to be obtained, and more specially the constituents of maternal blood during the gestation with a significant concentration and a high purity.

The invention therefore relates to a process in order to separate the constituents of maternal blood during gestation, in an analysis tube containing a separating medium allowing a density gradient to be obtained, and advantageously diluted maternal blood, characterized in that a layer of diluted separating medium is introduced into the tube between the layer of blood and that of the separating medium and that the contents of the tube are subjected to a centrifugation in order to separate the constituents of the blood into separate layers.

This process allows erythroblasts, lymphocytes, polynucleates and red corpuscles to be recovered separately. If appropriate, the erythroblasts are mixed with red corpuscles. It will be noted with interest that these different products have a degree of purity never achieved to this day and that the absence of contaminants gives them original structures. These are therefore products which, as such, are novel. Consequently, these products are also a subject of the invention.

Other characteristics and advantages of the invention are given in the following examples with reference to the figures which represent, respectively,

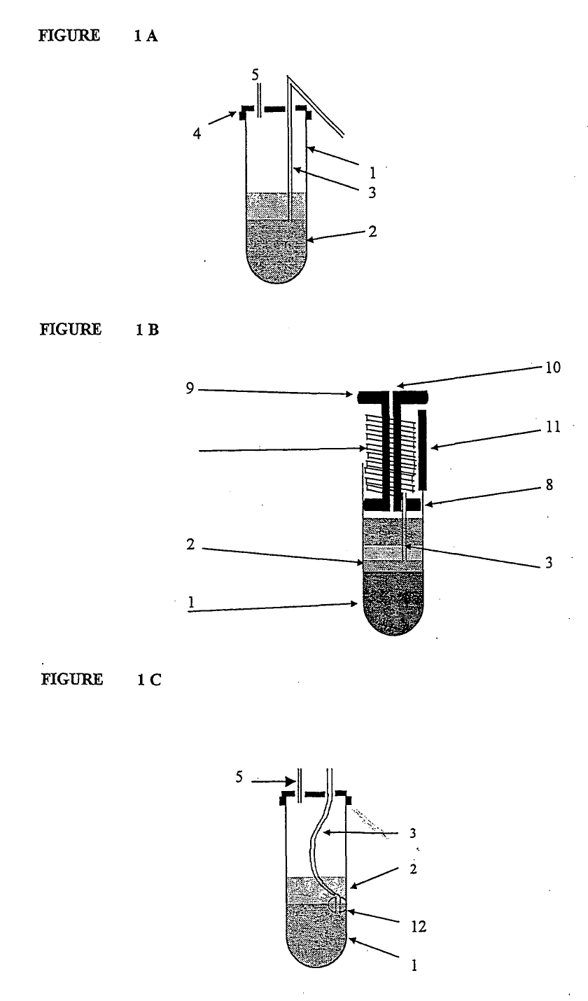

FIGS. 1A to 1E, devices for extraction by excess pressure,

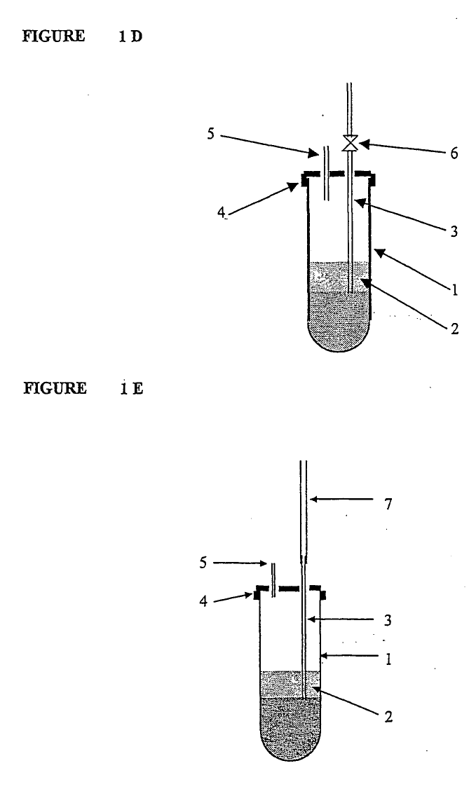

FIG. 2, a device for extraction by centrifugal force,

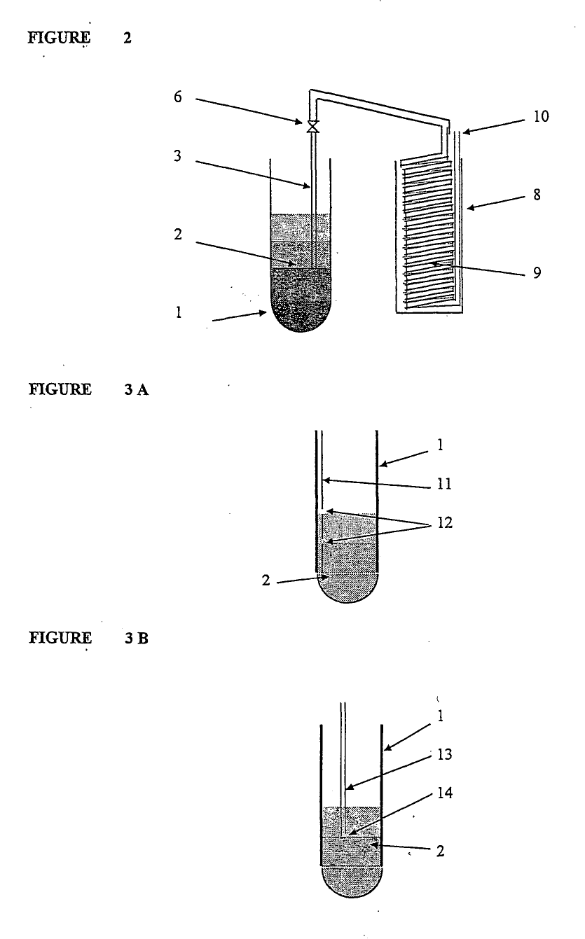

FIGS. 3A and 3B, injection devices,

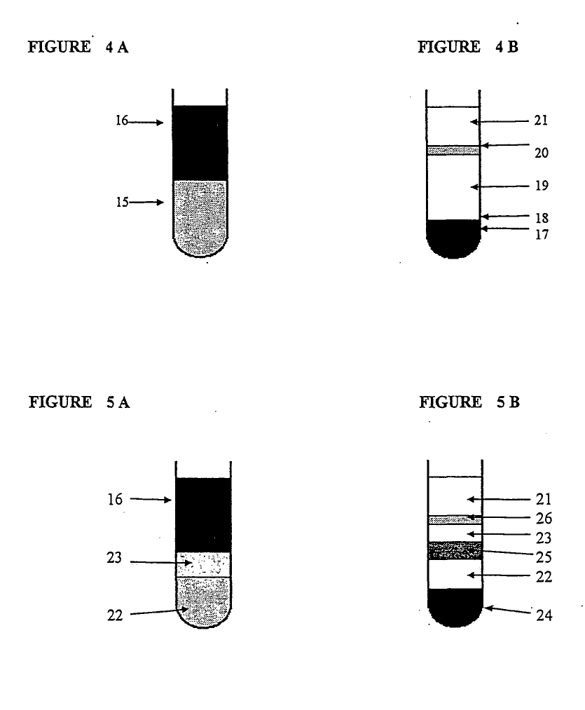

FIGS. 4A and 4B, a separation of the elements of blood using Ficoll® according to the standard technique, and

FIGS. 5A and 5B, a separation of erythroblasts and lymphocytes respectively from maternal blood, operating according to the invention.

1. Examples of Extraction Devices

According to an embodiment of the invention, the means capable of exerting an excess pressure in the analysis tube (1) form a hermetically sealed system, at the time of extraction, with the density gradient (2) and the extraction capillary (3).

These means comprise, in a variant represented in FIG. 1A, a stopper (4) intended to close the analysis tube (1) tightly and an excess-pressure tube (5) for the entry of the said fluid.

In another variant, the said means comprise an element, the movement of which allows the volume of the gaseous phase to be varied in the top part of the analysis tube, such as a piston, a membrane or a stopper.

In FIG. 1B, an extraction device is represented containing an extraction capillary (3) integral with a piston (8).

The piston (8) which can be operated by a push-button (9) is provided with an exhaust (10) which can be shut off. When the piston is introduced until it rests on a stop (11), this exhaust prevents the tube from being pressurized.

In another variant represented in FIG. 1C, the extraction capillary (3) is flexible. Its end is weighted by a mass (12) in order to constitute a Cartesian diver. The end of the extraction capillary positions itself in the liquid medium according to the apparent density of the Cartesian diver. The apparent density of the Cartesian diver is determined relative to that of the fraction to be extracted.

In yet another variant, the said means comprise a stopper (4) intended to hermetically close the analysis tube (1) and a heating element (not represented) placed in the upper part of the tube or in the stopper, causing the expansion of the gaseous phase in order to obtain the excess pressure.

According to another embodiment of the invention represented in FIG. 2, the said means allowing a laminar flow are the means capable of exerting a centrifugal force and comprise a support tube (8) which is able to be placed with the analysis tube (1) in a centrifuge (not represented), the support tube (8) containing a recovery capillary (9) with a straight or spiral-shaped return branch (10). The recovery capillary (9) is connected to the extraction capillary (3) and forms a siphon relative to this capillary. Some or all of the strips present in the analysis tube that are situated above the mouth of the extraction capillary can be contained in the recovery system (9). This system is for example a coil.

In a variant of this embodiment, in order to increase the centrifugal force, a mass forming a piston (not represented) is added into the analysis tube.

The extraction capillary (3) is able to be positioned at a variable height in the analysis medium, vertically or not, or as a variant, is fixed to the inside or outside of the tube.

It can be combined with the excess-pressure tube (5), forming a single two-way tube.

According to a provision of the invention, the extraction capillary forms a siphon. In another provision represented in FIG. 1D, the extraction capillary is provided with a valve (6). According to yet another provision represented in FIG. 1E, the extraction capillary (3) is connected to a recovery capillary (7). This recovery capillary is for example spiral-shaped or straight. The extraction capillary (3) or the recovery capillary (7) can be labelled or etched with marks at points determined according to the expected positioning of the fraction(s), and is optionally divisible at the level of the marks. The inside of the extraction capillary (3) or the recovery capillary (7) can be provided totally or partially with one or more biological and/or physical and/or chemical reagents. These are for example antigens, receptors, antibodies, proteins, molecular biology probes, lectins. It is thus possible to retain specifically in the capillary one part or one constituent of the fraction, or to retain specifically one contaminant. The capillary therefore resembles a liquid-phase chromatography column. The lower layers serve to push the fractions contained in the capillary.

The diameter of the capillary influences the rheological properties of certain products. Thus, according to the diameter and the length of the capillary, certain products are more or less held back, thus allowing the quality of the separation to be refined.

It will be seen that the upper outlet of the extraction capillary (3), or if appropriate of the recovery capillary (7) which is connected to it, can be linked to a fractions collector or directly to the inlet of an analyser, for example of a UV, mass, NMR spectrometer, of an HPLC or CPG (not represented).

In order to increase the selectivity of the separation, the said means allowing a laminar flow that are defined above comprise an analysis tube (1) with at least two conductive strips subjected to a potential difference or, as a variant, the analysis tube is placed in a magnetic field.

It will be seen that the extraction system is independent of the analysis tube and can be added extemporaneously to any analysis tube.

This system can be installed, partially or completely, before the separation of the layers.

It allows all or some of the constituents previously separated by density to be continuously extracted.

The different embodiments of the devices according to the invention are advantageously implemented in order to extract specifically one or more strips containing the desired products or constituents from an analysis tube comprising a plurality of strips such as defined above.

According to an embodiment of the invention, to this end, the laminar flow of the strip to be recovered towards an extraction capillary is ensured by exerting an excess pressure in the hermetically closed analysis tube, the desired strip is recovered from the extraction capillary, the operation being continued in order to obtain other strips if desired, moving successively from the densest to the least dense strip, without remixing from bottom to top.

The excess pressure is obtained by a variation in pressure, temperature or volume.

The variation in pressure is produced by injecting a fluid into the analysis tube through a tube called an excess-pressure tube. An inert gas, air or indeed a low-density liquid is used as a fluid.

As a variant, a variation in volume in the top part of the analysis tube is produced with the aid of an element such as a mobile piston, membrane or stopper.

The piston (8) which can be operated by a push-button (9) is provided with an exhaust (10) which can be shut off. When the piston is introduced until it rests on a stop (11), this exhaust prevents the tube from being pressurized. The end of the extraction capillary is then positioned just above the fraction to be extracted. Then the exhaust is sealed in order to render the “tube/piston” system tight.

The pressure exerted on the push-button is transmitted to the piston and to all the layers of the liquid that are located in the tube above the end of the extraction capillary.

Thus, the fractions located below the end of the extraction capillary rise successively inside the extraction capillary then into the recovery capillary.

The end of the extraction capillary, which is integral with the piston, sinks into the liquid as the fractions are extracted.

The fractions between the end of the extraction tube and the piston are not extracted from the tube.

A simple extraction capillary can also be used which terminates, at its end, in a mass forming a Cartesian diver which positions itself in the liquid medium according to the apparent density of the Cartesian diver, the apparent density being determined relative to that of the fraction to be extracted.

Another variant consists of producing a variation in temperature by heating the top part. After having positioned the extraction capillary, the contents of the analysis tube are then heated with the aid of a heating device which causes the expansion of the top part of the analysis tube and generates the desired excess pressure for the extraction of the strip to be recovered.

The whole density gradient is then pushed downwards, the upper layers resting uniformly on the lower layers.

The desired strip is recovered from the extraction capillary, the operation being continued in order to obtain other strips if desired, moving successively from bottom to top, from the densest strip to the least dense strip, without remixing.

The excess pressure pushes all the fractions located above the lower mouth of the extraction capillary. They rise successively inside the capillary. They leave the capillary via a siphon in ascending order of real or apparent densities. (The densest leaves first).

Thus, the fraction to be extracted rises in the extraction capillary, without disturbing either the bottom layer or the upper layers, which allows the total extraction of the different upper layers, successively and continuously, in reverse order (the densest first) without contamination or mixing and without extracting the downstream layers of greater densities.

As a variant, an extraction capillary containing a valve is used, which, by opening the valve, allows the reception of the layer to be extracted. By then closing the valve, the extracted fraction is isolated from the atmosphere, at the outlet of the extraction capillary. The capillary is then carefully removed from the analysis tube and the layer is recovered, expelling it by exposing it to the atmosphere, then it is deposited on a support provided for this purpose.

This variant allows the fraction isolated from the air to be protected, to be kept in its environment and thus provides a means of transport between the extraction device and the analysis site.

In yet another variant, a recovery capillary is connected to the extraction capillary, which allows specifically some of one constituent of the fraction to be retained or specifically one contaminant to be retained.

According to another embodiment of the invention, the laminar flow of the strip to be recovered is ensured by exerting a centrifugal force. To this end, a support tube containing a fraction-recovery system is introduced into a centrifuge alongside the analysis tube, the recovery system being connected to the extraction capillary, and the two tubes are subjected to a centrifugal force ensuring the passage of the strips located above the mouth of the extraction capillary into the recovery system, the operation being applied with different durations to other strips if desired.

The recovery system is removed from its support tube and the section(s) containing the desired strip(s) is/are cut. These sections can correspond to previously established marks.

For example, a coil is used as a recovery system.

According to yet another embodiment of the invention, the extraction is carried out in the presence of an electric field or a magnetic field.

The process of the invention is advantageously applied to separate layers with the aid, for example, of Ficoll®, Percoll®, albumin, cesium chloride, polyvinylpyrrolidone (PVP), glucose, glycerol or colloidal silica.

2. Examples of Injection Devices According to the Invention (Not Represented)

In an embodiment of the invention represented in FIG. 3A, the injection means are constituted by a capillary (11) integral with the internal wall of the analysis tube, containing grooves (12) perpendicular to the analysis tube (1), at heights pre-established according to the quantities of products to be injected into the analysis tube, which allows the product to arrive tangentially at the surface of the preceding layer.

The capillary is for example glued inside the tube, or as a variant, is formed by extrusion during the manufacture of the tube.

In another embodiment of the invention represented in FIG. 3B, the injection means are constituted by an injection needle (13), the penetration height of which into the tube is predetermined and/or contain a tangential injection nozzle (14).

The invention also relates to a process for the injection of products into an analysis tube, in the form of successive layers. This process is characterized by the successive introduction of predetermined quantities of the said products in order to ensure that these products arrive tangentially on the preceding layer.

This introduction is advantageously realized by injecting required quantities of products or liquids for a given layer into the capillary with the aid of a pipette or a calibrating dispenser, in order to bring the product tangentially to the surface of the preceding layer.

The products or liquids are introduced in ascending order of density, below the lower surface of the preceding layer, or as a variant in descending order of density above the upper surface of the preceding layer.

As a variant, a needle with tangential injection nozzle is introduced into the analysis tube, the penetration height being predetermined according to the height of the layers previously formed.

3 Separation of the Constituents of a Blood Mixture: Applications from a Removal of Maternal Blood During Gestation

Ficoll Histo-paque® is made of polysucrose and sodium diatrizoate, in variable quantities in order to obtain three isotonic liquids of different densities: 1.077; 1.083; 1.119. This reagent allows mononucleated elements to be separated from whole blood. Represented in FIG. 4A is an analysis tube containing a lower layer (15) of 2 ml of pure Ficoll® of density 1.077 and an upper layer (16) of 1 ml of blood diluted with 1 ml of PBS. The result of centrifugation for 20 minutes at 600 g from bottom to top, as represented in FIG. 4B, is layers of red corpuscles (17) and polynucleates (18), a layer of Ficoll® (19), then a strip of lymphocytes (20) surmounted by a strip or fraction of plasma (21).

A complex separation using Ficoll® in order to obtain pure erythroblasts free from any lymphocyte contamination was reported by Bhat et al. 1983 J. Immunol. Methods 158:277-280. This technique is based on the use of three layers of Ficoll® of different densities (1.119; 1.107; 1.077). It allows pure erythroblasts to be recovered, but the yields are so low that this technique works only with substantial samples containing large quantities of erythroblasts.

With suitable maternal samples of 5 ml, foetal erythroblasts are not successfully isolated using this technique.

This result is confirmed by Huber K. et al., 1996, Prenat. Diag. 16:1011-1019, who obtain 1% recovery after triple Ficoll® according to this method.

The study carried out by the inventors of a separation of the mononucleated elements from whole blood led to the following observations:

the red corpuscles resemble “piles of plates”, constituting a “formation roll”, which involves a profound change in the batches of red corpuscles.

the lymphocytes do not re-enter the Ficoll , but are placed above, at the interface with the serum,

the polynucleates settle on the surface of the residue of the red corpuscles: before centrifugation, the addition at the bottom of the tube of a small quantity of Ficoll® 1.119 makes it possible to have an interface between the red corpuscles and the polynucleates, thus facilitating the recovery of an erythrocyte pellet theoretically free from polynucleates.

Furthermore, it is noted that in the presence of Ficoll®, during the aggregation of the red corpuscles into a “formation roll”, foetal erythroblasts and polynucleates are randomly trapped.

the erythroblasts are not discernible to the naked eye in the lymphocyte strip. On the other hand, the addition of 200 μl of pure foetal blood to the maternal blood removed between the 14th and the 17th week of gestation shows a fine strip of erythroblasts visible in raking light on a black background. These erythroblasts appear individualized in a strip located between the lymphocyte strip and the Ficoll®.

Observations of the same type are made with other separating media such as mentioned above.

These studies led the inventors to develop a process in order to separate the constituents of the maternal blood during gestation, in an analysis tube containing a separating medium allowing a density gradient to be obtained, and advantageously diluted maternal blood, characterized in that a layer of diluted separating medium is introduced into the tube between the layer of blood and that of separating medium and that the contents of the tube are subjected to a centrifugation in order to separate the constituents of the blood into separate layers.

The dilution of the separating medium is chosen in order to obtain an increase in the space separating the lymphocytes/erythroblasts doublet.

Ficoll®, Percoll®, glucose, albumin, cesium chloride, polyvinylpyrrolidone (PVP), glycerol or colloidal silica will be cited as a suitable separating medium.

Satisfactory results are obtained by using pure Ficoll® as a separating medium and 15-25%, in particular 20% diluted Ficoll® for the separation of the lymphocytes/erythroblasts doublet. The pure Ficoll® advantageously has a density of 1.083 and the diluted Ficoll® of 1.069.

The blood sample is advantageously diluted with PBS or physiological serum.

FIG. 5A illustrates a tube containing, from bottom to top, the layers of pure Ficoll® (22), diluted Ficoll® (23) and diluted blood (16). FIG. 5B shows the separation into different layers after centrifugation, i.e. from bottom to top, the layers of red corpuscles (24), pure Ficoll® (22), erythroblasts (25), diluted Ficoll® (23), lymphocytes (26) and plasma (21).

This succession of layers constitutes a characteristic of the invention and therefore falls within its scope of protection.

The successive layers are advantageously deposited according to the techniques of the invention by firstly introducing the pure separating medium, then the diluted separating medium, and finally the mixture of diluted blood, containing if appropriate an anti-aggregating agent.

With the aid of the extraction techniques defined above, the removal of the desired strip is remarkably simple.

For example, in the case of an extraction carried out using maternal blood removed between the 14th and 17th week of pregnancy, the examination of each strip using a microscope gives the following data:

a carpet of red corpuscles in a “formation roll” at the bottom, coloured red,

the lymphocytes represent 10 to 30% of the nucleated cells; their nuclei are coloured blue by MGG coloration,

the foetal and adult erythroblasts represent 60 to 80% of the nucleated cells in the extracted layer. The optical intensity of the layer with the erythroblasts is proportional to the concentration of erythroblasts and of red corpuscles which are substantial in number, which suggests the formation of an erythroblasts/red corpuscles complex.

The technique of the invention allows a considerable increase in the concentration of erythroblasts in this layer, which thus rises from 10⁻⁵ to 10⁻¹ erythroblasts/red corpuscles.

The technique can be further improved by activating the extraction or recovery capillary either in order to fix the foetal cells by using for example (anti CD71, foetal anti-haemoglobin, anti-i . . . antibodies) or by fixing the contaminating maternal cells (adult anti-haemoglobin, anti-I antibodies, and lectins for example Aplysia gonad lectin).

Taking into account similarities between cancerous cells and foetal cells, this technique can be extended to the isolation of cancerous cells.

This process, allowing foetal cells to be fixed or contaminating adult cells to be eliminated by fixation, can be generalized to include the isolation by fixation of cancerous cells (with the aid of anti-i) or the elimination of anti-I contaminating healthy cells (with the aid of anti-I or Aplysia Gonad Lectin).

Examination of these isolated cells using a microscope showed that this erythroblasts/red corpuscles complex is not a structure in a “formation roll”, which explains the relative lightness of this whole relative to the very high density of the red corpuscles in a “formation roll” deposited at the bottom of the tube after separation by density gradient.

The repetition of this experiment on 1 ml of a pregnant woman's blood gives a very fine red strip at the level of the erythroblast localization. This red coloration is due to some co-migrant red corpuscles which then serve as tracers and favour the localization of this layer.

It is possible to increase the yields at the level of the erythroblast strip by enriching the removed maternal blood with exogenous erythroblasts which serve as tracers, for example reptile, bird, batrachian or camel blood.

The red corpuscles trapped in the “formation roll” are normal, i.e. in the shape of a flattened disc. This particular shape allows them to stack. The observation with a microscope of “tracer red corpuscles” (TRCs) in the erythroblast layer shows that they have escaped the process of “formation roll”. Their shapes are characteristic, and are for the most part spherical or “pear shaped”. The morphologies of such TRCs obtained from blood of patients with certain red corpuscle anomalies allow the aged or diseased cells to be characterized, such as observed for example in the Minkowsky pathologies, or in the case of thalassemia, the immature cells or those having shape anomalies.

It will be noted that the addition of an anti-aggregating agent to the blood sample allows a layer of red corpuscles to be obtained that have reacted with the anti-aggregating agent, which provides means for studying the effectiveness and the dosage of blood anti-aggregating agents for the treatment of blood pathologies.

The invention thus provides the means for having available different constituents of blood according to the quantities and degrees of purity which allow analyses and diagnoses to be carried out in particularly favourable conditions.

The invention thus relates in particular to the application of recovered erythroblast layers for the establishment of prenatal diagnoses of genetic pathologies. It also relates to the use of recovered lymphocyte layers for example in applications in cytapheresis.

An example of blood separation using Ficoll® is given below by way of illustration.

Preparation:

There is used 4 ml of 50/50 diluted blood in 4 ml of PBS and pure Ficoll® of density 1.083, and 20% diluted Ficoll®) in order to achieve a density of 1.069.

Deposition of the Layers:

There is deposited in a 4 ml tube

4 ml of Ficoll® of density 1.083,

2 ml of Ficoll® of density 1.069, and

8 ml of diluted blood.

Separation of the Layers:

A centrifugation is carried out at 600 g for 20 minutes.

There is obtained from bottom to top:

red corpuscles separated in the base of the tube

the layer of Ficoll®) of density 1.083,

a layer of erythroblasts mixed with red corpuscles located in the intermediate strip, of roughly 150 to 200 μl,

the layer of diluted Ficoll® of density 1.069,

a layer of lymphocytes located above the layer of diluted Ficoll®, surmounted,

by a layer of plasma.

Extraction:

The layer containing the desired constituents is extracted in a maximum of 500 μl of Ficoll® using the extraction techniques described above and recovered in a conical tube.

Washing Comprising:

dilution of the layer of product, in 2 ml of PBS+albumin (FV) 0.5 g/100 ml

mixing accompanied by gentle stirring, and

pelleting in a centrifuge at 500 g for roughly 7 minutes, followed by the decantation of the pellet.

These stages are repeated if necessary.

Preparation of the Product for the Purposes of Analysis:

The recovered product is suspended in pure PBS or PBS-A, SQF [sufficient quantity for] 0.5 ml. 250 μl are deposited on 2 microscope slides, according to the customary cytospin technique. For the purposes of observation using a microscope, coloration is carried out according to the customary M.G.G. technique.

4. Examples of Separations of Constituents Present in Mixtures

Purity Level of the Erythroblasts 10⁻² to 10⁻¹

The devices and extraction processes defined above are advantageously applied in the fields of research, in order to establish a biological diagnosis, or in order to carry out an analysis, or in a general manner in the field of industrial production, of drugs. The following will be cited by way of examples,

DNA/RNA separations,

in protein biochemistry, the separation of immunoglobulins on a sucrose gradient according to Ito T. et al in Pediatr.Nephrol. 15 Nov. 2000 (1-2):90-5, of complex macromolecules according to Hutchinson W. L. et al in Mol.Med 6 Jun. 2000 (6):482-483, of high molecular weight enzymes on a glycerol gradient according to Mo J. et al in Biochemistry 20 Jun. 2000; 39(24):7245-54, of membrane proteins on a sucrose gradient according to Geng L. et al in Biochim.Biophys.Acta 15 Dec. 2000; 1535(1):21-35,

the separations of organelles or fractions (cellular, bacterial, parasitic including oocytic, mycotic or viral) on a Percoll® gradient (Pertoft H., J Biochem Biophys Methods 10 Jul. 2000; 44 (1-2):1-30), of cells, of immune complexes, of lipoproteins according to Bakalova R. A. et al, Gen. Physio. Biophys. 2000 Mar. 19 (1):103-13, of different mucus on a cesium chloride gradient according to Montagné L. et al, J. Dairy Sci 2000 Mar.; 83 (3):507-17, of natural drugs, of products of partial or total synthesis,

in cytology and cancerology, the isolation of cancerous cells of the prostate from whole blood (Wang Z. P. et al, Cancer 2000, 15 Jun.; 88(12):2787-95),

in reproductive biology, the separation of spermatozoids (Zini A. et al, Urology 20 Dec. 2000; 56(6):1081-4),

in galenics, the separation of liposomes, emulsions, micelles, lipocores, nanocapsules, (Perkins W. R. et al, Int.J.Pharm. 25 Apr. 2000; 200(1):27-39 or Mosqueira V. C., J. Pharm. Sci., May 2000; 89(5):614-26),

in zoology, the isolation of Xenopus ovocytes (Richter H. P. et al, Biol.Cell. 1995; 84(3):129-38),

in parasitology, the isolation of Opisthorchis viverrini eggs (J. Helminthol. December 1998; 72(4):359-61, the isolation of Dirofilaria immitis (Exp.Parasitol, Aug. 1995; 81(1):63-71; the separation of the mucus of a pig infected with Ascaris suum (Vet.Parasitol. September 1988; 29(2-3):143-58).

For guidance, reported below are examples of gradients such as given in Centrifuge (a) 2nd edition, A practical approach, D. Rickwood (Ed.) Kontron (1987) according to the products to be separated.

(In the following tables, (e.g.) means “for example”).

TABLE 1
Applications of different types of isopycnic gradient

| | | | | | Sub- | | |
|---|---|---|---|---|---|---|---|
| | | | | | cellular | | |
| | | | Nucleo- | Mem- | organ- | | Vi- |
| Gradient | DNA | RNA | proteins | branes | elles | Cells | ruses |
| Sugar | − | − | + | ++ | ++ | + | ++ |
| (e.g. sucrose) | | | | | | | |
| Poly- | − | − | − | + | + | +++ | ++ |
| saccharides | | | | | | | |
| (e.g. Ficoll ®) | | | | | | | |
| Alkali metal | +++ | ++ | + | − | − | − | ++ |
| salts | | | | | | | |
| (e.g. CsCl) | | | | | | | |
| Colloidal silica | − | − | − | + | ++ | ++ | + |
| (e.g. | | | | | | | |
| Percoll ®) | | | | | | | |
| Iodized non- | + | + | +++ | +++ | +++ | ++ | ++ |
| ionic | | | | | | | |
| compounds | | | | | | | |
| (e.g. | | | | | | | |
| Nycodenz ®) | | | | | | | |

The classification is as follows:
+++ good;
++ satisfactory;
+ limited application;
− inapplicable

TABLE 2
Apparent densities of biological particles in sucrose solutions

| | | | Centrifugation | Apparent density |
|---|---|---|---|---|
| Particles | Gradient | | conditions | (g/cm³) |
| Plasmatic liver | sucrose | | 100,000 g for 1.5 h | 1.13-1.18 |
| membranes | | | | |
| Lysosomes | sucrose | | | 1.21-1.22 |
| Mitochondria | sucrose | {close oversize brace} | 59,000 g for 4 h | 1.19 |
| Peroxisomes | sucrose | | | 1.23 |
| Peroxisomal | sucrose | | | 1.25 |
| plants | | | | |
| Thylacoids | sucrose | {close oversize brace} | 65,000 g for 40 h | 1.17 |
| Chloroplasts | sucrose | | | 1.22 |
| Chromatin | sucrose/ | | 50,000 g for 40 h | 1.36 |
| | glucose | | | |
| Informosomes | sucrose/ | | 180,000 g for 20 h | 1.29 |
| | D₂O | | | |
| Murine | sucrose | | 65,000 g for 1 h | 1.16 |
| sarcoma virus | | | | |
| Murine | sucrose | | 240,000 g for 1 h | 1.17 |
| mammary | | | | |
| tumor viruses | | | | |
| Canine virus | sucrose | | 88,000 g for 16 h | 1.20 |

TABLE 3
Apparent densities of cells and viruses in Ficoll ® gradients

| | | Apparent density |
|---|---|---|
| Particles | Centrifugation conditions | (g/cm³) |
| Membranes | 100,000 g for 16 h | 1.05 |
| Chromatophores | 195,000 g for 36 h | 1.07 |
| Brain vesicles | 21,000 g for 15 min | — |
| Mitochondria | 80,000 g for 2 h | 1.136 |
| Hepatic cells | 6,000 g for 2 h | 1.10-1.15 |
| Fibroblast cells | 8,000 g for 60 min | 1.05 |
| Ehrlich ascites cells | 1,400 g for 45 min | 1.07 |
| Mammary tumor viruses | 59,000 g for 60 min | 1.14 |

TABLE 4
Apparent densities of biological particles in iodized gradients
(Hinton R. H. and Mullock B. M. (1976), Rickwood D. (ed.), iIRL
press, Oxford and Washington and Rickwood D., ed. (1983), IRL
press Oxford and Washington

| | | Apparent density | | |
|---|---|---|---|---|
| | Centrifugation | (g/cm³) | | |
| Particles | conditions | metrizoate | metrizamide | Nycodenz ® |
| Native DNA | 65,000 g for 44 h | 1.13 | 1.11 | 1.13 |
| Denatured DNA | 65,000 g for 44 h | 1.14 | 1.14 | 1.17 |
| RNA | 65,000 g for 44 h | 1.23 | 1.17 | 1.18 |
| Proteins | 163,000 g for 72 h | | | |
| haemoglobin | | 1.27 | | |
| catalase | | | 1.27 | 1.29 |
| b-alactosidase | | | | 1.25 |
| serum albumin | | | 1.22 | |
| Polysaccharides | 80,000 g for 48 h | | | |
| glycogen | | 1.48 | 1.28 | 1.29 |
| dextran blue | | | 1.19 | 1.19 |
| hyaluronic acid | | | 1.10 | |
| chondroitin sulphate | | | 1.08 | |
| Nucleoproteins | 150,000 g for 68 h | | | |
| polysomes | | | 1.34 | 1.33 |
| messenger RNA | | | 1.21 | |
| 90S ribosomes | | | 1.33 | 1.30 |
| chromatin | | 1.20 | 1.16-1.20 | 1.17-1.19 |
| metaphase chromosomes | | 1.19 | 1.24 | 1.29 |
| Organelles | 100,000 g for 16 h | | | |
| membranes | | | 1.14-1.26 | 1.11-1.19 |
| lysosomes | | 1.15 | 1.13 | 1.15 |
| mitochondria | | | 1.16 | 1.17 |
| peroxisomes | | | 1.22 | 1.22 |
| nuclei | | | | 1.23 |
| nucleolus | | | 1.24 | |
| Cells | 10,000 g for 30 mi | | | |
| lymphocytes | | 1.07 | | 1.07 |
| erythrocytes | | 1.15 | | 1.11 |
| hepatic parenchyma | | | 1.12 | 1.14 |
| Viruses | 200,000 g for 18 h | | | |
| Polio virus | | 1.29 | 1.31 | 1.30 |
| Coxsackie virus | | | 1.18 | 1.18 |
| Semliki forest virus | | | 1.20 | 1.18 |
| Newcastle disease virus | | 1.14 | | |
| bacteriophage T7 | | 1.27 | | |

TABLE 5
Density and separation conditions for the isolation of cells,
viruses and subcellular particles in a Percoll ® gradient
(Wakefield J. S. J. et al (1982) Biochem. J., 202, 795; Pertfot H. et
al, (1979) Pergamon Press, London and New York, p. 67; and
Pertoft H. et al (1979) Biochem. Vol. 9, Reid E. (ed.), Ellis
Horwood, Chichester, p. 67.

| | | Starting | | Density | | |
|---|---|---|---|---|---|---|
| | | density | Osmotic | obtained | | |
| Particles | | (g/cm³) | solution | (g/cm³) | | Procedure |
| Organelles | | | | | | |
| plasma membranes | | 1.04 | sucrose | 1.02-1.03 | | |
| microsomes | | 1.05 | sucrose | 1.03-1.05 | | |
| peroxisomes | | 1.07 | sucrose | 1.05-1.07 | | 63,000 g for 30 min |
| mitochrondria | | 1.06 | sucrose | 1.09-1.11 | | 50,000 g for 45 min |
| lysosomes | | 1.05 | sucrose | 1.04-1.07 | | 50,000 g for 45 min |
| | | | | 1.08-1.11 | | |
| synaptosomes | | 1.04 | sucrose | 1.04-1.06 | | 50,000 g for 45 min |
| nuclei | | 1.10 | sucrose | 1.08-1.12 | | 100,000 g for 60 min |
| chromaffin granules | | Preformed | sucrose | 1.06-1.07 | | 10,000 g for 30 min |
| Hepatic rat cells | | | | | | |
| hepatocytes | | 1.07 | Eagle | 1.07-1.10 | | 30,000 g for 30 min |
| | | | gradient | | | |
| Kupffer cells | | 1.06 | Eagle | 1.05-1.06 | | 30,000 g for 30 min |
| | | | gradient | | | |
| Human blood cells | | | | | | |
| thrombocytes | | | | 1.04-1.06 | | |
| lymphocytes | | | | 1.06-1.08 | | |
| granulocytes | {close oversize brace} | 1.090 | Hepes-NaOH buffer | 1.08-1.09 | | |
| erythrocytes | | | | 1.09-1.10 | | |
| Testicular cells | | | | | | |
| Leydig cells | | Preformed | sucrose | 1.06 | | |
| | | | | | {close oversize brace} | 800 g for 20 min |
| spermatids | | Preformed | sucrose | 1.04 | | |
| Bacteria | | | | | | |
| E. coli | | 1.10 | PBS | 1.13 | | 30,000 g for 20 min |
| Viruses | | | | | | |
| tobacco mosaic virus | | 1.06 | sucrose | 1.06 | | 100,000 g for 45 min |
| equine abortion virus | | 1.10 | 0.01 M tris- | 1.08 | | 40,000 g for 45 min |
| | | | HCL | | | |
| influenza virus | | 1.05 | 0.01 M tris- | 1.06 | | 25,000 g for 25 min |
| | | | HCL | | | |
| rotavirus | | 1.10 | sucrose | 1.08 | | 50,000 g for 45 min |

1. A device for the extraction of one or more strips containing the desired products or constituents from an analysis tube (1) containing a plurality of separate adjacent or overlapping strips, in a liquid medium, forming a continuous or discontinuous density gradient (2), characterized in that it comprises:
a standard analysis tube (1),
an extraction tube or capillary (3), which can be pre-positioned according to the layer to be extracted, and
means for obtaining a laminar flow of one or more strips from the tube without suction, either by applying excess pressure onto the top of the liquid medium with a low-density fluid, gas or liquid, or by exerting a centrifugal force.

2. The device according to claim 1, characterized in that the means capable of exerting an excess pressure comprise a stopper (4) intended to hermetically close the analysis tube and an excess-pressure tube (5) for the entry of the said fluid, the whole forming, with the extraction capillary (3) and the density gradient (2), a system hermetically sealed at the time of extraction.

3. The device according to claim 2, characterized in that the said excess-pressure means comprise an element, the movement of which ensures a variation in volume of the gaseous phase in the top part of the analysis tube (1), such as a piston, a membrane or a stopper.

4. The device according to claim 1, characterized in that the means capable of exerting an excess pressure comprise a stopper (4) intended to hermetically close the analysis tube (1) and a heating element placed in the upper part of the tube or in the stopper, causing the expansion of the gaseous phase in order to obtain the excess pressure.

5. The device according to claim 1, characterized in that the said means capable of exerting a centrifugal force comprise a support tube (8) which can be placed with the analysis tube (1) in a centrifuge, and housed in the support tube (8), a recovery capillary (9) with a spiral-shaped or straight return branch (10), this system being connected to the extraction capillary (3), comprising if appropriate a valve (6), and capable of constituting a siphon relative to this capillary, and of containing all of the strips present in the analysis tube that are located above the mouth of the extraction capillary, the said analysis tube containing if appropriate a mass forming a piston.

6. The device according to claim 1, characterized in that the extraction capillary (3) is able to be positioned at a variable height in the analysis medium, vertically or not, or as a variant, is fixed to the inside or outside of the tube.

7. The device according to claim 6, characterized in that the extraction capillary (3) is provided with a valve (6) or is connected to a spiral-shaped or straight recovery capillary (7).

8. The device according to claim 7, characterized in that the extraction capillary (3) or the recovery capillary (7) is labelled or etched with marks at points determined according to the expected positioning of the fraction(s), and is optionally divisible at the level of the marks.

9. The device according claim 7, characterized in that the inside of the extraction capillary (3) or the recovery capillary (7) is provided totally or partially with one or more physical, chemical or biological reagents.

10. The device according to claim 1, characterized in that the analysis tube (1) comprises at least two conductive strips subjected to a potential difference or, as a variant, is placed in a magnetic field.

11. A process for the specific extraction of one or more strips containing the desired products or constituents in an analysis tube containing a plurality of separate adjacent or overlapping strips, in a liquid medium, characterized in that it comprises the following stages:
an extraction capillary is introduced into a standard analysis tube using a guide ensuring its positioning in the space at the desired height relative to the strip to be extracted or, as a variant, an analysis tube is used with a capillary pre-positioned at the desired height, located inside or partly outside the tube,
means are applied in order to obtain a laminar flow without suction, either by excess pressure via the top of the liquid medium with a low-density gas or fluid, or by exerting a centrifugal force.

12. The process according to claim 11, characterized in that the laminar flow of the strip to be recovered towards an extraction capillary is ensured by exerting an excess pressure in the hermetically closed analysis tube, and the desired strip is recovered from the extraction capillary, the operation being continued in order to obtain other strips if desired, moving successively from bottom to top from the densest strip to the least dense strip, without remixing.

13. The process according to claim 11, characterized in that the excess pressure is obtained by a variation in pressure, by injecting a fluid into the analysis tube through a tube, by a variation in volume, by moving an element such as a mobile piston, membrane or stopper in the top part of the analysis tube, or by a variation in temperature, by heating the contents of the analysis tube in order to cause the expansion of its top part.

14. The process according to claim 11, characterized in that a recovery capillary is connected to the extraction capillary in order to retain specifically one part or one constituent of the fraction, or a contaminant.

15. The process according to claim 14, characterized in that chemical, physical or biological reagents are introduced into the extraction capillary or into the recovery capillary.

16. The process according to claim 11, characterized in that the laminar flow of the strip to be recovered is ensured by exerting a centrifugal force, by introducing a support tube containing a fraction-recovery capillary in a centrifuge alongside the analysis tube, the recovery capillary being connected to the extraction capillary, and by subjecting the two tubes to a centrifugal force ensuring the passage of the strips located above the mouth of the extraction capillary into the recovery capillary, the operation being applied with different durations to other strips, if desired.

17. The process according to claim 11, characterized in that the extraction is carried out in the presence of an electric field or a magnetic field.

18. The process according to claim 11, characterized in that it is applied to layers separated in Ficoll®, Percoll®, glucose, cesium chloride, albumin, polyvinylpyrrolidone, glycerol or colloidal silica.

19. The device according to claim 1, characterized in that it is connected to a device for the injection into an analysis tube (1) of products, in the form of successive layers, by the introduction of predetermined quantities of products or of liquids with different densities, characterized in that the analysis tube (1) comprises injection means allowing the products to arrive tangentially in predetermined quantities.

20. The device according to claim 19, characterized in that the injection means are constituted by a capillary (11) integral with the internal wall of the analysis tube, containing grooves (12) perpendicular to the analysis tube (1), at heights pre-established according to quantities of products to be injected into the analysis tube, which allows the product to arrive tangentially at the surface of the preceding layer.

21. The device according to claim 19, characterized in that the injection means are constituted by an injection needle (13), the penetration height of which into the tube is predetermined and/or containing a tangential injection nozzle (14).

22. The process according to claim 11, characterized in that it also contains a stage of injection into an analysis tube of products in the form of successive layers, characterized by the introduction of predetermined quantities of the said products in order to ensure that these products arrive tangentially onto the preceding layer, by carrying out the injection into the tube, with the aid of a pipette or a calibrating dispenser, of the required quantities of products or of liquids for a given layer in order to bring the product tangentially to the surface of the preceding layer or, as a variant, a needle with a tangential injection nozzle is introduced into the analysis tube, the penetration height being predetermined according to the height of the previously formed layers.

23. The device according to claim 1, wherein the device is suitable for the extraction of a layer or of several layers of constituents of a blood mixture in a separating medium containing, if appropriate, an anti-aggregating agent.

24. The device according to claim 23, further comprising the incorporation, in an analysis tube containing a separating medium allowing a density gradient and diluted maternal blood, removed during gestation, to be obtained, of a layer of diluted separating medium between the layer of blood and that of separating medium and in that the contents of the tube are subjected to a centrifugation in order to separate the constituents of the blood into separate layers.

25. The device according to claim 24, wherein the device is suitable for the extraction of foetal erythroblasts of maternal blood and/or of the lymphocyte layer and/or of the polynucleates and/or of the residue of red corpuscles.

26. The device according to claim 24, wherein the device is suitable for the establishment of a prenatal diagnosis of foetal genetic diseases.

27. The device according to claim 23, wherein the device is suitable for the extraction of cancerous cells in blood of blood or tissue origin, such as the prostate, breast, lung or ovary.

28. The process according to claim 11, wherein the process is suitable for the extraction of a layer or of several layers of constituents of a blood mixture in a separating medium containing, if appropriate, an anti-aggregating agent.

29. The process according to claim 28, further comprising the incorporation, in an analysis tube containing a separating medium allowing a density gradient and diluted maternal blood, removed during gestation, to be obtained, of a layer of diluted separating medium between the layer of blood and that of separating medium and in that the contents of the tube are subjected to a centrifugation in order to separate the constituents of the blood into separate layers.

30. The process according to claim 29, further comprising the extraction of foetal erythroblasts of maternal blood and/or of the lymphocyte layer and/or of the polynucleates and/or of the residue of red corpuscles.

31. The process according to claim 29, further comprising the establishment of a prenatal diagnosis of foetal genetic diseases.

32. The process according to claim 28, comprising the extraction of cancerous cells in blood of blood or tissue origin, such as the prostate, breast, lung or ovary.
